(19) United States
(12) Patent Application Publication
(10) Pub. No.: US 2017/0028424 A1
(43) Pub. Date: Feb. 2, 2017

(54) FILTER FOR A HIGH-PRESSURE NOZZLE, HIGH-PRESSURE NOZZLE AND METHOD FOR PRODUCING A FILTER FOR A HIGH-PRESSURE NOZZLE

(71) Applicant: Siegfried FOSHAG, Wolfschlugen (DE)

(72) Inventor: Siegfried FOSHAG, Wolfschlugen (DE)

(21) Appl. No.: 15/214,651

(22) Filed: Jul. 20, 2016

(30) Foreign Application Priority Data
Jul. 27, 2015 (DE) 10 2015 214 123.3

(51) Int. Cl. B05B 15/00; B01D 29/11; B05B 1/02; B01D 35/02

(52) U.S. Cl. CPC B05B 15/008; B01D 35/02; B01D 29/114; B05B 1/02

(57) ABSTRACT

A filter for a high-pressure nozzle having a tubular section and a cap section. The cap section and/or the tubular section are provided with a plurality of filter slots which extend in the longitudinal direction of the tubular section and each have a first end situated on the side of the tubular section and a second end situated on the side of the cap section. A sleeve is arranged coaxially with the tubular section and covers the filter slots in the region of the first end of the filter slots.

### CROSS-REFERENCE TO RELATED APPLICATIONS

This claims priority from German Patent Application No. 10 2015 214 123.3, filed on Jul. 27, 2015, the disclosure of which is hereby incorporated by reference in its entirety into this application.

### FIELD OF THE INVENTION

The invention relates to a filter for a high-pressure nozzle having a tubular section and a cap section, wherein the cap section and/or the tubular section are provided with a plurality of filter slots, which extend in the longitudinal direction of the tubular section and each have a first end situated on the side of the tubular section and a second end situated on the side of the cap section.

### BACKGROUND OF THE INVENTION

A high-pressure nozzle having a finer is known from European Patent EP 1 992 415 B1. High-pressure nozzles of this kind are provided for spraying liquids at pressures that may be several 100 bar to 600 bar. For example, high-pressure nozzles of this kind are used to descale steel products. For this purpose, a nozzle housing, which is provided with the filter, is inserted into a connection nipple or a connection tube. The liquid to be sprayed then passes through the filter slots into the flow channel of the high-pressure nozzle, which then leads to the nozzle outlet. It is proposed to embody the filter as a sintered part in order thereby to enable configuration of the end boundary surfaces of the inlet slots in any desired manner and, especially, in a manner which is favourable in terms of flow.

German Utility Model DE 297 06 863 U1 has disclosed another high-pressure nozzle. This high-pressure nozzle likewise has a filter, which is provided with a plurality of slots extending in the longitudinal direction. These slots are sawed into the filter housing by means of a circular saw blade.

A high-pressure nozzle for descaling steel products, having a filter which has a plurality of filter slots extending in the longitudinal direction of the tubular section of the filter, is also known from U.S. Pat. No. 4,848,672. The filter slots are sawed into the filter by means of a circular saw blade. Provided downstream of the filter is a jet straightener, which is inserted into the flow channel of the nozzle in order to align the flow in the longitudinal direction and, above all, to avoid turbulence.

### SUMMARY OF THE INVENTION

The invention is intended to improve a filter, a high-pressure nozzle and a method for producing a filter.

According to the invention, this purpose is served by providing a filter for a high-pressure nozzle having a tubular section and a cap section, wherein the cap section and/or the tubular section are provided with a plurality of filter slots, which extend in the longitudinal direction of the tubular section and each have a first end situated on the side of the tubular section and a second end situated on the side of the cap section, in which a sleeve arranged coaxially with the tubular section is provided, said sleeve covering the filter slots in the region of the first end of the filter slots.

By means of the sleeve, the filter slots are covered in the region of the first end, which is situated on the side of the tubular section. As a result, the configuration of the first end of the filter slots no longer plays a role in the inflow of the liquid under high pressure, e.g. between 50 bar and 800 bar, into the filter or plays only a negligible role. This is because the sleeve covers the filter slots in the region of the first end of the filter slots, when seen in the radial direction. In order to flow in through the filter slots, the liquid must thus pass through the end of the sleeve and flows past the first end of the filter slots only to a negligible extent. Simply through providing a sleeve which conceals or covers the first end of the filter slots when viewed in the radial direction, a significant improvement in the flow conditions at a filter for high-pressure nozzles can be achieved. It has been observed that the formation of turbulence as the liquid flows in in the region of the first end of the filter slots can be prevented or largely avoided. Compared with high-pressure nozzles according to the prior art, in which the filter is produced as a sintered part, thus allowing the first end of the filter slots to be configured in a manner that is advantageous in terms of flow, or compared with mechanical finish machining of the first end of the filter slots, the solution according to the invention represents a considerable simplification, especially in terms of production engineering. After the sawing of the filter slots, the sleeve is arranged at least in the region of the first end of the filter slots. As a result, the filter slots no longer have to be finish-machined. This represents a considerable alleviation, especially when producing filters of this kind in large numbers, since the filter slots are normally very narrow and generally have a width of about 1 mm in order to perform their filtering function. The high-pressure nozzle according to the invention is provided for descaling steel products, for example.

As a development of the invention, the sleeve is arranged within the tubular section and/or the cap section and forms a flow channel through the filter, at least in some section or sections.

The arrangement of the sleeve within the tubular section and/or the cap section can be implemented in a relatively simple manner. For example, an axial bore is made in the filter housing, and the sleeve is then inserted into said bore. By means of the sleeve, the webs between the filter slots can be mechanically stabilized, this being advantageous especially when pressure surges occur.

As a development of the invention, a central bore of the sleeve is widened towards the upstream end.

The sleeve forms a flow channel through the nozzle, at least in some section or sections, and the liquid to be sprayed flows through the filter slots into the upstream end of the sleeve. Widening the central bore of the sleeve towards the upstream end can reduce a flow resistance of the sleeve and prevent the occurrence of turbulence, thereby ensuring enhanced performance from the high-pressure nozzle provided with the filter.

As a development of the invention, an end face of the sleeve is of rounded design at the upstream end.

Rounding the end face of the sleeve at the upstream end also contributes to a reduced flow resistance and, as a result, to an improvement in the performance of the high-pressure nozzle provided with the filter.

As a development of the invention, the sleeve rests against an outer side of the tubular section and/or of the cap section.

Arranging the sleeve on the outer side of the filter also makes it possible to cover or conceal the filter slots in the region of the first end of the filter slots. It is a particularly simple matter to arrange a sleeve on the outer side of the filter, e.g. simply by sliding the sleeve onto the filter and subsequently fixing it.

As a development of the invention, the sleeve rests against an outer side or an inner side of the tubular section or of the cap section, at least in the region of the first end of the filter slots.

Flow through the filter slots in the region of the first end of the slots is thereby largely prevented. As a result, the configuration of the first end of the filter slots plays only a negligible role or no role in relation to the flow resistance or any turbulence that occurs in the liquid entering the filter.

The problem underlying the invention is also solved by a high-pressure nozzle having a filter according to the invention.

As a development of the invention, provision is made in a high-pressure nozzle according to the invention for the sleeve to be arranged within the tubular section and to form a flow channel through the filter, at least in some section or sections, wherein a free flow cross section of the sleeve corresponds to the free flow cross section in the nozzle housing at the downstream end of the sleeve.

A stepless transition between the sleeve and the extension of the flow channel in the nozzle housing is thereby possible. It is thereby possible to prevent the occurrence of turbulence, and the performance of the high-pressure nozzle is improved.

The problem underlying the invention is also solved by a method for producing a filter for a high-pressure nozzle in which the sawing of filter slots into a tubular section and/or a cap section of the filter parallel to a longitudinal direction of the tubular section and the arrangement of a sleeve coaxially with the tubular section is provided, with the result that the sleeve covers the filter slots in the region of the first end of the filter slots.

Sawing filter slots into a tubular section and/or a cap section of the filter can also be achieved relatively simply and with a reliable process when producing in large numbers. Sawing filter slots is preferred here to milling filter slots. This is because the width of the filter slots is normally in a region of 1 mm, and the handling of milling cutters of such a diameter is extremely sensitive. The convexly shaped end of the filter slots which forms during the sawing of the filter slots no longer plays a role in terms of flow engineering if, in accordance with the invention, a sleeve is arranged coaxially with the tubular section, with the result that the sleeve covers the filter slots in the region of the first end of the filter slots. It is thereby possible in a surprisingly simple way to combine the production-engineering advantages of sawing the filter slots with a configuration of the first end of the filter slots which is advantageous in terms of flow.

As a development of the invention, the sleeve is arranged within the tubular section and/or the cap section.

As a development of the invention, the sleeve can be arranged on an outer side of the tubular section and/or of the cap section.

The scope of the invention covers the arrangement of two sleeves, namely a first sleeve being arranged within the tubular section and/or the cap section and a second sleeve being arranged on an outer side of the tubular section and/or of the cap section. Such a solution is complex but can be provided when special installation conditions, size ratios or flow conditions require it.

Further features and advantages of the invention will become apparent from the claims and the following description of preferred embodiments of the invention in combination with the drawings. Here, individual features of the different embodiments shown or described can be combined in any desired manner without exceeding the scope of the invention. In the drawings:

### BRIEF DESCRIPTION OF THE DRAWINGS

FIG. 1 shows a high-pressure nozzle according to the invention in a view obliquely from below,

FIG. 2 shows a view of the high-pressure nozzle of FIG. 1 from behind,

FIG. 3 shows the high-pressure nozzle of FIG. 1 in a side view,

FIG. 4 shows the high-pressure nozzle of FIG. 1 in a front view,

FIG. 5 a view of section plane A-A in FIG. 3,

FIG. 6 a view of the filter of the high-pressure nozzle of FIG. 1 obliquely from above,

FIG. 7 a view of the filter of FIG. 6 from behind,

FIG. 8 a side view of the filter of FIG. 6,

FIG. 9 a view of the filter of FIG. 6 from the front,

FIG. 10 a view of section plane A-A in FIG. 8,

FIG. 11 a sectional view of a filter according to the invention for a high-pressure nozzle according to another embodiment,

FIG. 12 a connection nipple with a high-pressure nozzle according to the invention fitted,

FIG. 13 a view of section plane A-A in FIG. 12 and

FIG. 14 the enlarged view of detail Y in FIG. 13.

### DETAILED DESCRIPTION

The illustration in FIG. 1 shows a high-pressure nozzle 10 according to the invention, wherein the high-pressure nozzle 10 has a housing 12, a nozzle 14, only a section of which can be seen in FIG. 1, and a filter 16 connected to the housing 12.

Liquid to be sprayed enters the filter 16 through a plurality of filter slots 18 extending in the longitudinal direction of the filter and passes through them into a flow channel (not visible in FIG. 1) in the interior of the nozzle housing 12. The liquid to be sprayed passes to the nozzle mouthpiece 14 and specifically to the outlet opening in the nozzle mouthpiece 14 and emerges in the form of a fan jet in the embodiment shown.

The high-pressure nozzle 10 shown is provided for descaling steel products. A pressure of the liquid to be sprayed is typically in a range of from about 50 bar to several 100 bar, e.g. 800 bar. The mechanical requirements on the high-pressure nozzle 10 are therefore considerable since pressure surges can occur in the pipes leading to the high-pressure nozzle 10, and these can then also have significantly higher pressure spikes. The filter 16 normally projects into a pipe through which the liquid to be sprayed is supplied. As a result, the filter 16 is exposed to high mechanical stresses, and turbulence which occurs as the liquid to be sprayed enters through the filter slots 18 also affects the performance of the high-pressure nozzle 10 in a disadvantageous way.

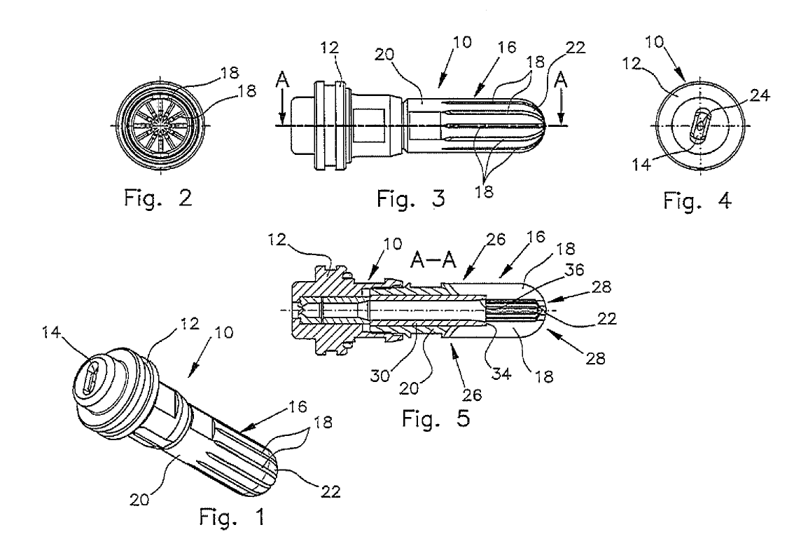

The illustration in FIG. 2 shows the high-pressure nozzle 10 of FIG. 1 from behind, i.e. as seen in the direction of flow. It can be seen that the filter slots 18 are arranged in a radial direction in the filter 16.

In the embodiment shown, the filter 16 has a tubular section 20 and a cap section 22. The filter slots 18 extend in the longitudinal direction of the tubular section 20 and are arranged both in the cap section 22 and in the tubular section 20.

From the ends of the filter slots 18 in FIG. 1 and FIG. 2, it can be seen that these are made using a circular saw blade which ends in a linear edge at its circumference. For this reason, each of the ends of the filter slots 18 also runs out in an edge. In the context of the invention, provision is likewise made here to make the filter slots 18 with a saw blade which is of rectangular configuration at its circumferential edge.

The illustration in FIG. 3 shows a side view of the high-pressure nozzle 10. In this view too, the filter slots 18 introduced in the longitudinal direction of the tubular section 20 can be seen, extending from the cap section 22 into the tubular section 20. In the illustrated embodiment of the high-pressure nozzle 10, a circular-cylindrical section of the filter 16 is referred to as the tubular section 20. The approximately hemi-spherical section which closes off one end of the tubular section 20 is then referred to as the cap section. In the embodiment illustrated, the filter 16 is of integral design. The filter 16 can be produced from a turned brass cap, into which the filter slots 18 are sawed, for example.

The illustration in FIG. 4 shows the high-pressure nozzle 10 of FIG. 1 from the front. In addition to the nozzle housing 12, the nozzle mouthpiece 14 with the outlet opening 24 can be seen.

The sectional view in FIG. 5 enables the configuration of the filter slots 18 to be seen. The filter slots 18 each have a first end 26 and a second end 28, wherein the first end 26 is situated on the side of the tubular section 20 and the second end 28 is situated on the side of the cap section 22. The first end 26 is thus arranged at the downstream end of the filter slots 18 in the direction of flow through the high-pressure nozzle 10 and the second end 28 is arranged at the upstream end of the filter slots 18, as seen in the direction of flow. As already explained, both ends 26, 28 taper to an edge. This is brought about by the fact that the filter slots 18 are sawed using a circular saw blade that tapers at the edge. As already explained, the ends 26, 28 of the filter slots 18 can also be of rectangular configuration if they are sawed using a saw blade of rectangular edge design.

In the illustration in FIG. 5, the filter slots 18 are sawed from the right. The circular saw blade is moved from right to left and thus cuts through the cap section 22 first and then enters the tubular section 20. The feed motion of the saw blade is then stopped and the shape of the first end 26 of the filter slots 18, which is arranged on the left in FIG. 5, is obtained. The shape of the first end 26 follows the outer contour of the saw blade and consequently forms a convex surface. Towards the centre of the filter 16, this surface merges into a sharp edge, although this cannot be seen in the illustration in FIG. 5 since a sleeve 30 is already arranged there. However, it can be seen in the illustration in FIG. 11 how the edge at the transition between a central bore 32 of the filter 16 to the filter slots 18 is designed. More specifically, this circumferential edge follows a zigzag line caused by the configuration of the saw blade. The configuration of this edge in FIG. 11 arises because a saw blade with a circumferential tapering edge is used. If, instead, a saw blade with an edge which does not taper but is rectangular is used, it would not be a zigzag line but an edge which was obtained, said edge being characterized by a plurality of grooves which are arranged spaced apart and are each rectangular.

In all cases, the profile of this sharp edge is of unfavourable configuration for flow and contributes to the generation of turbulence. To prevent the formation of such turbulence or at least to prevent it as far as possible, the sleeve 30 in the nozzle according to the embodiment in FIG. 5 is inserted into the filter. For this purpose, the central bore of the filter is of step-shaped design, thus allowing the sleeve 30 to be inserted into the filter from the left as far as an offset 34 in the illustration in FIG. 5. The offset 34 is situated upstream of the first ends 26 of the filter slots 18, as seen in the direction of flow. As a result, liquid which enters the filter 16 from outside through the filter slots 18 must flow into that end of the sleeve 30 which is situated upstream and on the right in FIG. 5. It can be seen from FIG. 5 that, as a result, the shape of the first end 26 of the filter slots 18 plays virtually no role anymore in relation to the liquid flowing in. This is because the decisive inlet edge for the liquid is now defined by that end of the sleeve 30 which is situated upstream and on the right in FIG. 5. As a consequence, there is now only a weak flow through the first end 26 of the filter slots since, of course, the sleeve 30 covers the filter slots 18 in the region of the first end 26.

A central bore of the sleeve 30 is embodied so as to widen at its upstream end, i.e. the end situated on the right in FIG. 5. More specifically, a cone 36 which widens counter to the direction of flow is provided in the embodiment illustrated. The liquid to be sprayed enters via this cone 36, which then tapers in the direction of flow. The flow resistance at the inlet to the sleeve 30 is thereby reduced. The end face of the sleeve 30 directed counter to the flow, i.e. the end face of the sleeve 30 arranged on the right in FIG. 5, can furthermore be of rounded design in order to further reduce a flow resistance. It should be taken into account here that it is only in the region of the filter slots 18 that this end face of the sleeve 30 arranged on the right in FIG. 5 is impinged upon by the liquid to be sprayed. Between the filter slots 18, the webs which separate the filter slots 18 also cover the end face of the sleeve 30.

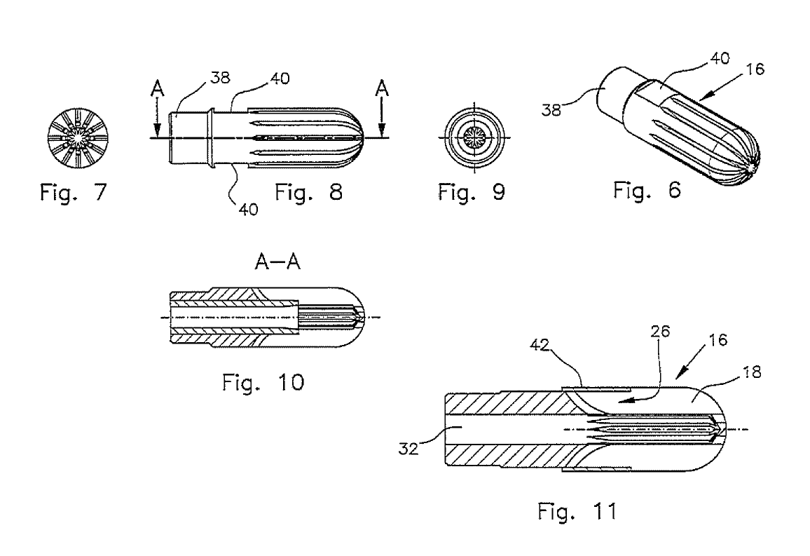

The illustrations in FIGS. 6 to 10 show the filter 16 before assembly with the nozzle housing 10. The filter 16 is secured in the housing 10 by means of a cylindrical section 38, which can be provided with a thread.

The filter 16 is provided with two opposite, flat engagement surfaces 40 for a spanner to enable the filter 16 to be screwed into the housing 10.

As already mentioned, the illustration in FIG. 11 shows another embodiment of a filter 16 according to the invention. To avoid repetitions, only those features are described here which differ from those in the filter shown in FIGS. 1 to 10.

The filter 16 in FIG. 11 is provided with a sleeve 42, which rests against a radially outer outer surface of the filter 16. As a result, the sleeve 42 covers the first ends 26 of the filter slots 18 and thereby prevents the shape of the first ends 26 of the filter slots 18 from being able to cause increased turbulence and, as a result, increased flow resistance, as the liquid to be sprayed enters the filter 16.

More specifically, it can be seen from FIG. 11 that the liquid flows directly into the filter slots 18 from that end of the sleeve 42 which is situated on the right in FIG. 11, i.e. the upstream end. In the region of the first ends 26 of the filter slots 18, in contrast, there is only a negligible flow. As a result, the shape of the first ends 26 of the filter slots 18, which is determined by the sawing of the slots by means of a circular saw blade, causes only slight turbulence and only slightly increased flow resistance.

Since the sleeve 42 is mounted on the outside of the filter 16 in FIG. 11 and rests on the outer surface of the filter 16, the central bore 32 of the filter 16 itself forms a section of the flow channel through the high-pressure nozzle.

Both in the embodiment in FIGS. 1 to 10 and the embodiment in FIG. 11, it has been found that, by virtue of the sleeves 30 and 42, each covering the first ends 26 of the filter slots 18, the ends situated on the side of the tubular section 20 of the filter 16, the liquid to be sprayed is subject to so little turbulence after entering the filter 16 that it is normally possible to dispense with a jet straightener in the rest of the flow channel up to the outlet opening 24. As a result, the high-pressure nozzle 10 according to the invention can be manufactured at low cost and, since a jet straightener always also causes flow resistance, is extremely powerful. More specifically, an “impact”, i.e. a contact impulse of the fan jet produced on a surface to be descaled, is greater in comparison with conventional nozzles according to the prior art.

If the inlet flow to the filter is very unfavourable, a jet straightener can have a calming effect on the flow. A jet straightener can be provided in the high-pressure nozzle according to the invention and can be installed in the sleeve 30, for example.

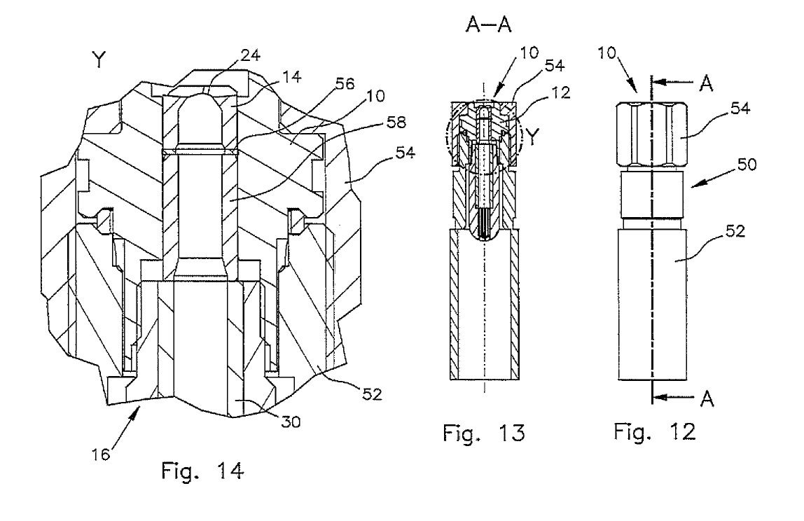

The illustration in FIG. 12 shows a connection nipple 50, in which the high-pressure nozzle 10 according to the invention is installed, in a side view. In the view in FIG. 12, however, the high-pressure nozzle 10 is not visible. The connection nipple 50 has a tubular section 52, onto the free end of which, at the top in FIG. 12, a union nut 54 is screwed.

In the sectional view in FIG. 13 in section plane A-A in FIG. 12, it can be seen that the housing 12 of the high-pressure nozzle is preloaded against the connection nipple 52 by means of the union nut 54. The high-pressure nozzle 10 is thereby held reliably and yet in an easily exchangeable manner on the connection nipple 52. The connection nipple 52 can mark the end of a pipe via which the liquid to be sprayed is supplied. However, the connection nipple 52 can also be welded into a pipe extending perpendicularly to the connection nipple 52, for example.

The illustration in FIG. 14 shows the enlarged detail Y in FIG. 13. It shows the outlet opening 24, from which a fan jet emerges and which is provided on a nozzle mouthpiece 14. When viewed counter to the direction of flow, that is to say from top to bottom in FIG. 14, the mouthpiece 14 is followed within the nozzle housing 10 first of all by a ring seal 56, then by an intermediate sleeve 58 and then, if appropriate with the interposition of a further ring seal (not shown), the sleeve 30, which is inserted into the filter 16. It can be seen that the diameter of a flow channel in the sleeve 30 corresponds to the diameter of the flow channel at the upstream end of the intermediate sleeve 58. As a result, the liquid to be sprayed can be passed to the outlet opening 24 with small pressure losses.

The nozzle mouthpiece 14 advantageously consists of hard metal in order to ensure a long service life of the high-pressure nozzle 10.

1. Filter for a high-pressure nozzle having a tubular section and a cap section, wherein the cap section and/or the tubular section are provided with a plurality of filter slots, which extend in the longitudinal direction of the tubular section and each have a first end situated on the side of the tubular section and a second end situated on the side of the cap section, wherein a sleeve arranged coaxially with the tubular section is provided, said sleeve covering the filter slots in the region of the first end of the filter slots.

2. Filter according to claim 1, wherein the sleeve is arranged within the tubular section and/or the cap section and forms a flow channel through the filter, at least in some section or sections.

3. Filter according to claim 1, wherein a central bore of the sleeve is widened towards the upstream end.

4. Filter according to claim 3, wherein an end face of the sleeve is of rounded design at the upstream end.

5. Filter according to claim 1, wherein the sleeve rests against an outer side or an inner side of the tubular section or of the cap section, at least in the region of the first end of the filter slots.

6. High-pressure nozzle having a filter according to claim 1.

7. High-pressure nozzle according to claim 6, wherein the sleeve is arranged within the tubular section and forms a flow channel through the filter, at least in some section or sections, and in that a free flow cross section of the sleeve corresponds to the free flow cross section in the nozzle housing at the downstream end of the sleeve.

8. Method for producing a filter for a high-pressure nozzle, including the steps of sawing filter slots into a tubular section and/or a cap section of the filter parallel to a longitudinal direction of the tubular section and arranging a sleeve coaxially with the tubular section, with the result that the sleeve covers the filter slots in the region of a first end of the filter slots.

9. Method according to claim 8, including arranging the sleeve within the tubular section and/or the cap section.

10. Method according to claim 8, including arranging the sleeve on an outer side of the tubular section and/or of the cap section.

11. Method according to claim 8, including arranging the sleeve coaxially with the tubular section so that the sleeve covers the filter slots in an end region of the filter slots situated adjacent the tubular section.
